(19) United States
(12) Patent Application Publication
(10) Pub. No.: US 2005/0102624 A1
(43) Pub. Date: May 12, 2005

(54) Method of creating a customized image product

(75) Inventor: Dale F. McIntyre, Honeoye Falls, NY (US)

Correspondence Address: Milton S. Sales;Patent Legal Staff, Eastman Kodak Company, 343 State Street, Rochester, NY, 14650-2201, US

(73) Assignee: Eastman Kodak Company

(21) Appl. No.: 10/705,661

(22) Filed: Nov. 10, 2003

(51) Int. Cl. G06F 3/00

(52) U.S. Cl. 715/723; 715/765; 715/776; 715/724; 715/725; 715/732

(57) ABSTRACT

A software product and method for providing a customized image product to a user. The method included the steps of providing a computer readable media having a software program that will cause a computer to perform a predefined series of steps used to create the customized image product from a template. The computer readable media further includes digital image content, a credit toward the cost of the customized image product, and a unique identifier; loading the computer readable media in the computer and thereby causing activation of the software, the software automatically allowing use of the digital image content; the user composing the customized image product; and the user ordering the customized image product wherein the unique identifier is used to identify the credit and the template.

### FIELD OF THE INVENTION

A method and computer media product for use in constructing and ordering customized image products.

### BACKGROUND OF THE INVENTION

Many software packages exist today to create customized image products. A customized image product is an image product where a user has made selections from a large number of images and includes text as an enhancing part of the image product. Such software may be provided on a computer readable media such as a compact disc (CD) or may be downloaded from the internet. It allows a user to create a custom image product like a photo collage, albums, calendars etc. However, the user must install the application into their computer, which requires a number of steps and consumes considerable hard disk space on the user's computer. Such an installation typically requires an extended amount of time and often requires the user to restart the computer to finish the installation. If the computer has a problem with the hard disk drive, the application may need to be reinstalled at a future date. An example of such software is FotoFusion by Lumapix Inc. FotoFusion allows a user to make a photo collage and this software is provided for a fee in the form of a CD for installation on a user's computer. If the user only makes a few photo collages, they have incurred a high cost for the purchase of the software that they haven't used too often. The user has paid for a license to use the software, but not paid anything toward the fulfillment of a customized image product. Furthermore, in such an example, the user must direct the software to the location of the stored digital images to be used in cooperation with the software.

Computer media products such as the Picture CD product from Eastman Kodak Co. contains software and digital images that automatically activate upon placement of the Picture CD into a user's computer as a slide show. However, the Picture CD product still includes a small installation component and isn't used to create a customized image product. Furthermore, the Picture CD doesn't include a unique identifier for identifying a template for producing a customized image product, nor does it include a credit toward the ordering of a customized image product from a fulfillment provider.

There exists a need to simplify the creation of customized image products without undue steps and direction from a user. Furthermore, there exists a need to keep a user financially motivated to reap the emotional benefits of custom image products in addition to reducing the complexity of the user's participation.

There also exists a need to order customized image products from a fulfillment provider without establishing an account or using a pre-existing account. There also exist a need to not require a user to be tied to a particular computer or other device in order to use particular software owned and/or controlled by the user.

### SUMMARY OF THE INVENTION

In accordance with one aspect of the present invention there is provided a method for providing a customized image product to a user, comprising the steps of obtaining a computer readable media having a software program such that when the computer readable media is placed in a computer the software will cause the computer to perform a predefined series of steps used to create the customized image product from a template, the computer readable media further includes digital image content, a credit toward the cost of the customized image product, and a unique identifier; loading the computer readable media in the computer and thereby causing activation of the software, the software automatically allowing use of the digital image content; the user composing the customized image product; and the user ordering the customized image product wherein the unique identifier is used to identify the credit and the template.

In accordance with another aspect of the present invention there is provided a computer readable media having a software program such that when the computer readable media is placed in a user computer the software will cause the user computer to perform a predefined series of steps used to create the customized image product from a template, the computer readable media further includes digital image content, a credit toward the cost of the customized image product, and a unique identifier, the software automatically allowing use of the digital image content upon activation and for ordering the customized image product; the software have information for allowing the ordering over a communication network.

In accordance with yet another aspect of the present invention there is provided a method for providing a customized image product to a user, comprising the steps of;
obtaining a computer readable media having a software program such that when the computer readable media is placed in a user computer the software will cause the user computer to perform a predefined series of steps used to create the customized image product from a template, the computer readable media further includes digital image content, a credit toward the cost of the customized image product, and a unique identifier, the software further allows the user to obtain additional digital images from other sources that can also be used to compose the customized image product;
loading the computer readable media in the user computer and thereby causing activation of the software, the software automatically allowing use of the digital image content and the additional digital images;
the user composing the customized image product; and
the user ordering the customized image product wherein the unique identifier is used to identify the credit and the template.

In accordance with still another aspect of the present invention there is provided a method for providing a customized image product to a user, comprising the steps of;
providing a plurality of images by the user to a fulfillment provider;
the fulfillment provider providing a computer readable media having a software program such that when the computer readable media is placed in a user computer the software will cause the user computer to perform a predefined series of steps used to create the customized image product from a template, the computer readable media further includes digital image content which includes the images provided to the fulfillment provider, a credit toward the cost of the customized image product, and a unique identifier;
loading the computer readable media in the user computer and thereby causing activation of the software, the software automatically allowing use of the digital image content;
the user composing the customized image product; and
the user ordering the customized image product wherein the unique identifier is used to identify the credit and the template.

In accordance with another aspect of the present invention there is provided a method for providing a customized image product to a user, comprising the steps of,
providing a plurality of images by the user to a computer readable media order station;
the computer readable media order station providing a computer readable media having a software program such that when the computer readable media is placed in a user computer the software will cause the user computer to perform a predefined series of steps used to create the customized image product from a template, the computer readable media further includes digital image content which includes the images provided to the fulfillment provider, a credit toward the cost of the customized image product, and a unique identifier;
loading the computer readable media in the user computer and thereby causing activation of the software, the software automatically allowing use of the digital image content;
the user composing the customized image product; and
the user ordering the customized image product wherein the unique identifier is used to identify the credit and the template.

These and other aspects, objects, features and advantages of the present invention will be more clearly understood and appreciated from a review of the following detailed description of the preferred embodiments and appended claims and by reference to the accompanying drawings.

### BRIEF DESCRIPTION OF THE DRAWINGS

In the detailed description of the preferred embodiments of the invention presented below, reference is made to the accompanying drawings in which:

FIG. 1 is a plan view of the computer readable media made in accordance with the present invention;

FIG. 2 is a screen shot of the initial screen displayed to the user upon activation of the software provided on the computer readable media described in FIG. 1.;

FIG. 3a-3h illustrate successive screens displayed to the user upon composing a custom image product in accordance with one embodiment of the present invention;

FIG. 4 is a flow chart illustrating the steps in the use of the software to compose a customized image product in accordance with the present invention;

FIGS. 5a and 5b are order forms for ordering the computer readable media and specifying the additional digital image content to be included thereon;

FIG. 6 is a flow chart illustrating the steps in the ordering of a computer readable media including film images and an order form;

FIG. 7 is a flow chart illustrating the steps in the ordering of a computer readable media from a computer readable media order station with digital images provided from a digital image source; and

FIG. 8 is a flow chart illustrating the steps for ordering the computer readable media from an online service provider also made in accordance with the present invention.

### DETAILED DESCRIPTION OF THE INVENTION

In accordance with the present invention, a retail media package 12 is shown which includes a computer readable media 10 such as a CD and a label 14 which indicates the intended customized image product template (Keepsake Book) and theme (Yosemite National Park) to a potential user or purchaser. Additional examples of computer readable media include removeable magnetic disks of various storage capacities or solid state removable memory which can also be provided. Computer readable media 10 includes data representing digital image content related to the theme, which is by way of the current example, but not by limitation, Yosemite National Park. Digital image content will be understood to include stock photography, maps, aerial photos, clip art, points of interest, historical news, digital video, audio clips and any other digital files that can be useful in producing a customized image product related to the theme. Computer readable media 10 further includes data representing a unique identifier and executable software which when activated operates on digital image content to produce a customized image product in accordance with the included template for the customized image product. It will be understood that the unique identifier is preferably encrypted to prevent theft. The unique identifier encodes the specific customized image product template used by the executable software to produce a customized image product such as a keepsake book. The unique identifier may also encode a credit, usable in whole or in part, towards the purchase of the customized image product.

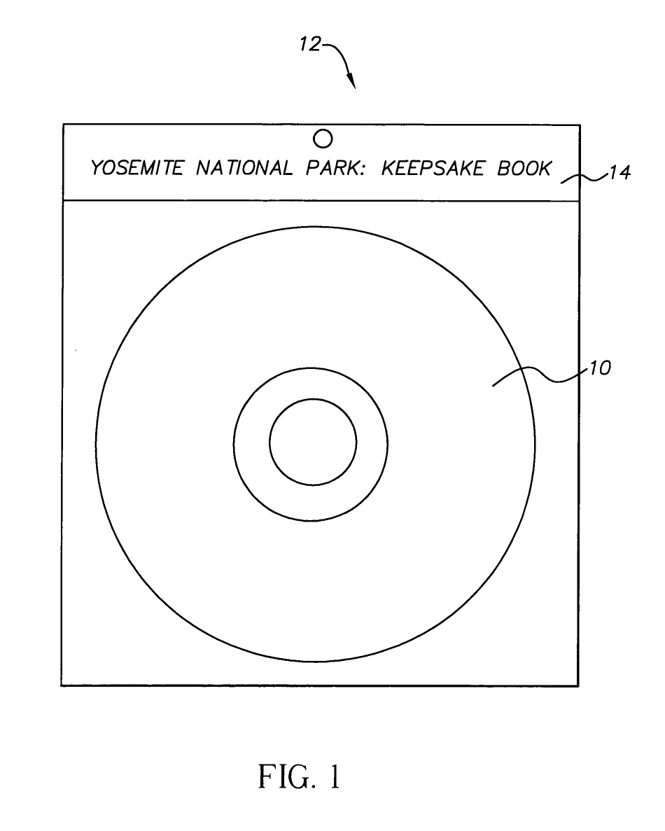

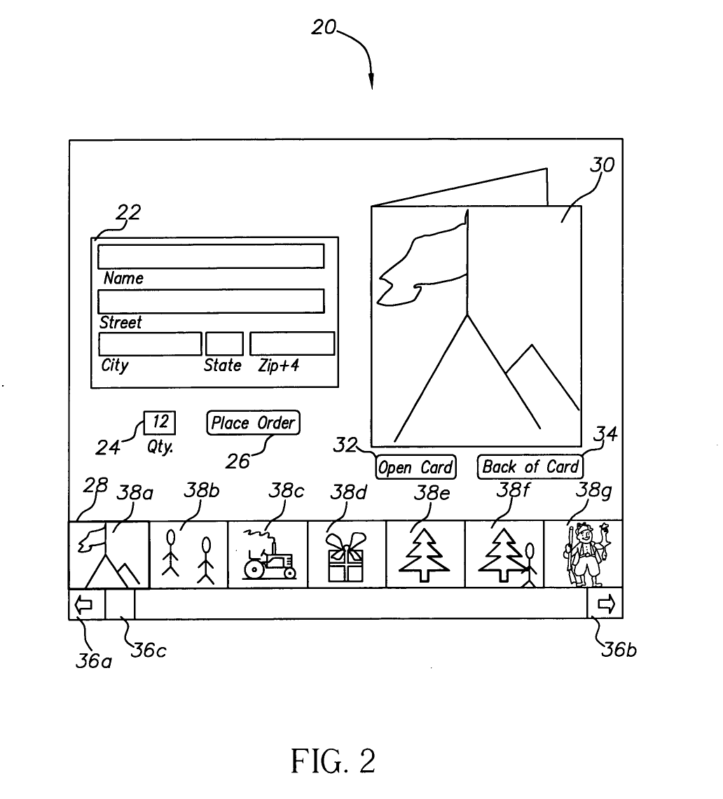

Turning now to FIG. 2, a screen shot of the initial screen 20 is displayed to the user upon activation of the software provided on the computer readable media described in FIG. 1. Having inserted the computer readable media 10 into the user computer, the software program provided on the computer readable media 10 is activated and causes the user computer to perform a predefined series of steps that result in screen 20 being displayed to the user. This predefined series of steps does not include installing any software programs on the user computer as this technique requires considerable hard disk space and places a burden on the user to regularly update the software program to be compatible with changes in the operating system of the user computer. Since the software program has not been permanently installed on the computer, but instead is running from the CD and/or RAM (Random Access Memory), there is no need go through a lengthy installation process or be limited to a particular computer.

It is important to note that without doing anything except placing the computer readable media into the user computer, the user is presented with a screen that includes an address block 22 with conventional fields 23a, 23b, 23c to provide delivery information, a quantity block 24 for indicating order quantity, and button 26 for causing an order to be placed. Screen 20 further includes a template 30 of the customized image product to be produced by the user interacting with the activated software program, and a choice of digital image content 38a-38g. Digital image content 38a-38g referred to as a group or in general will be denoted by digital image content 38. Digital image content 38a-38g are depicted in this example as digital still images, but this is not a limitation of the invention. Additional digital image content 38 may be revealed when the user interacts with content control elements 36a, 36b, and 36c whose functions are commonly understood in the art.

The default configuration of the customized image product includes digital image content 38a as it is the first available digital image content 38. Highlight outline 28 circumscribes digital image content 38a and indicates it's status as being the current selection. A user operating the user computer can select other digital image content 38 using common computer input devices for selecting such as a mouse. Optionally, the software program can allow the user to obtain other digital image content 38 from portable memory devices, online image storage services, or storage locations within the user computer. Buttons 32 and 34 cause the computer, in this example, to display the interior of the card and the back of the card respectively. Functionality of these buttons 32 and 34 changes depending on which view of template 30 is being displayed to the user in effect, helping the user choose another view of template 30.

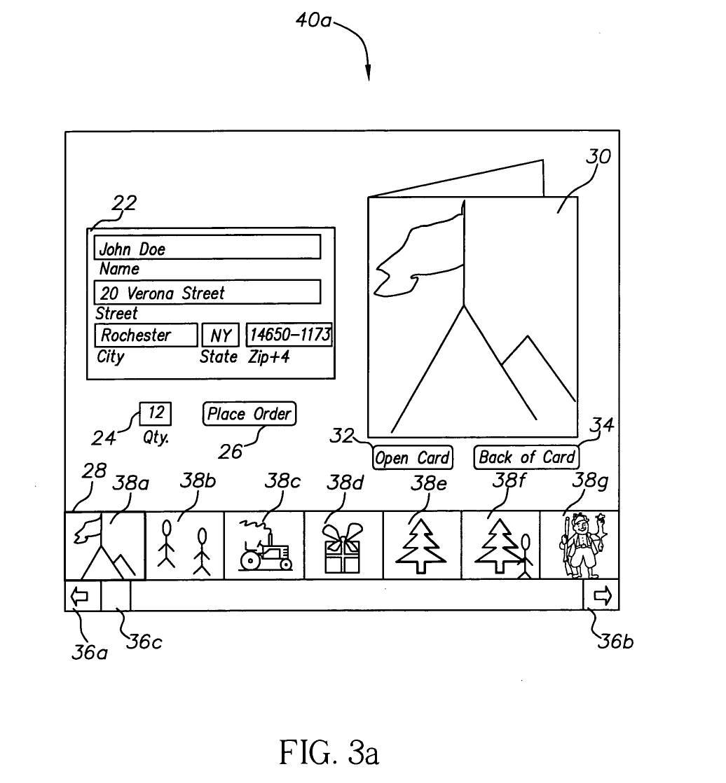

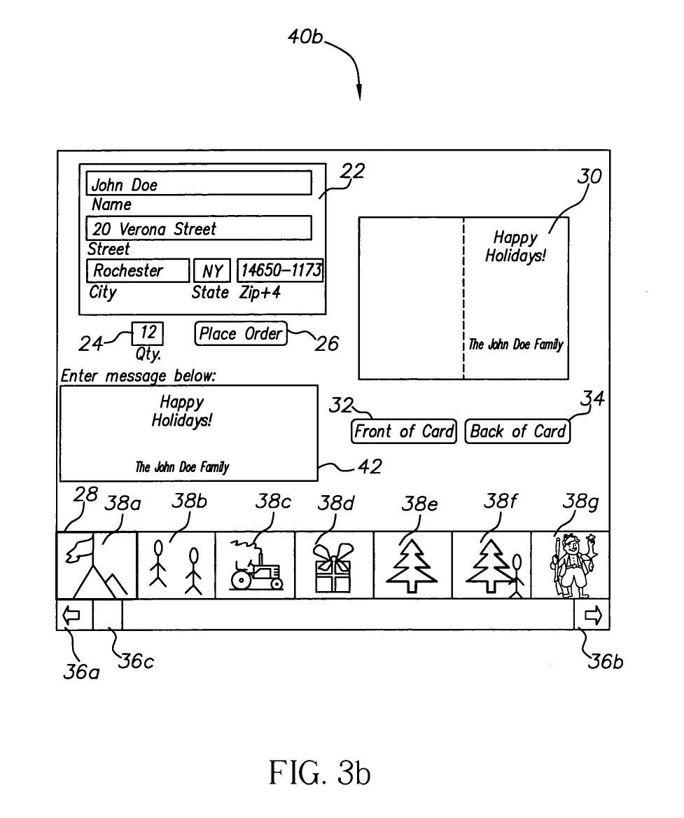

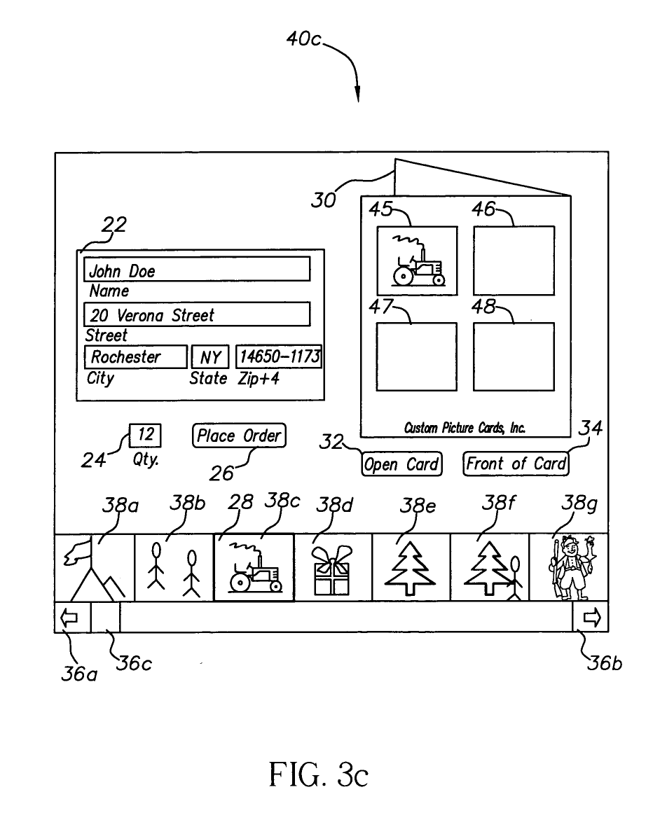

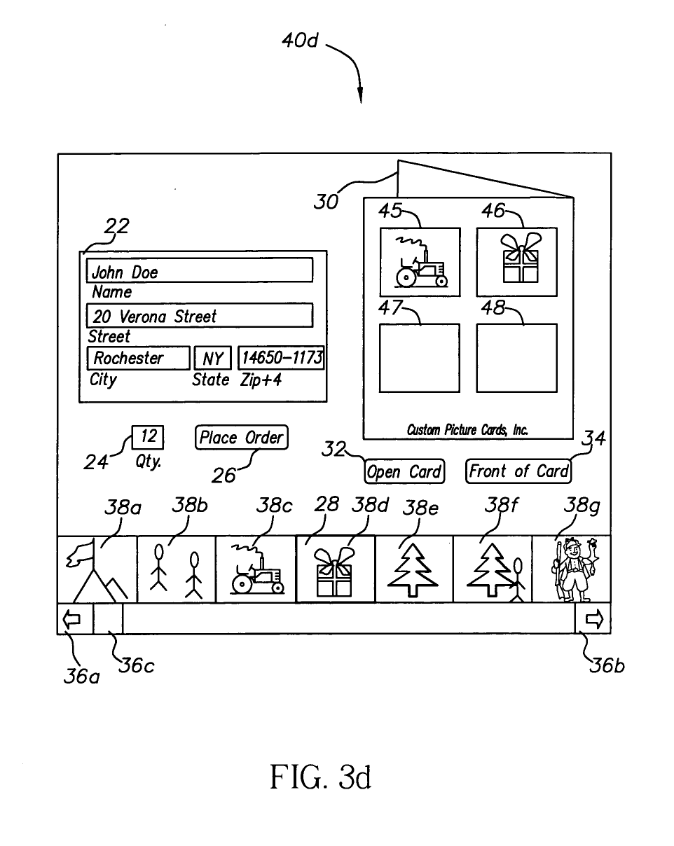

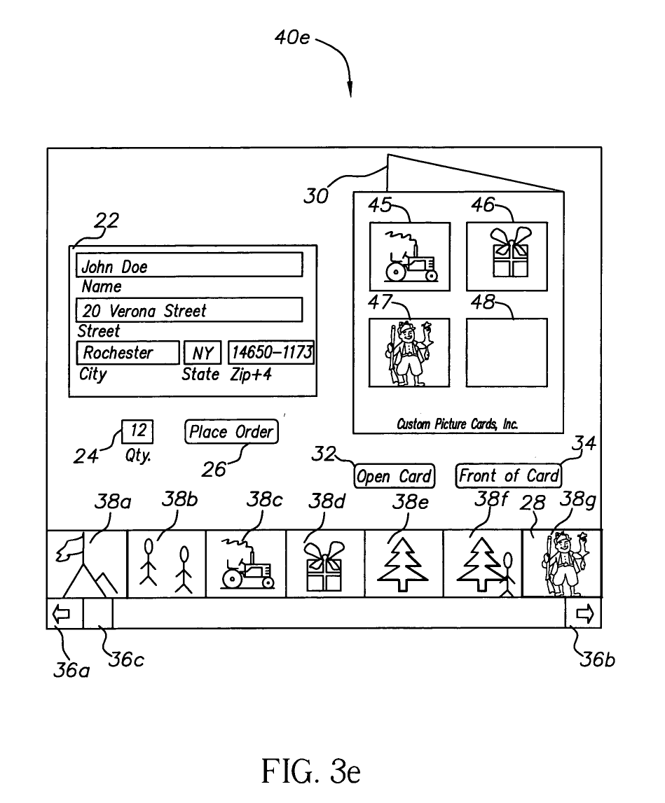

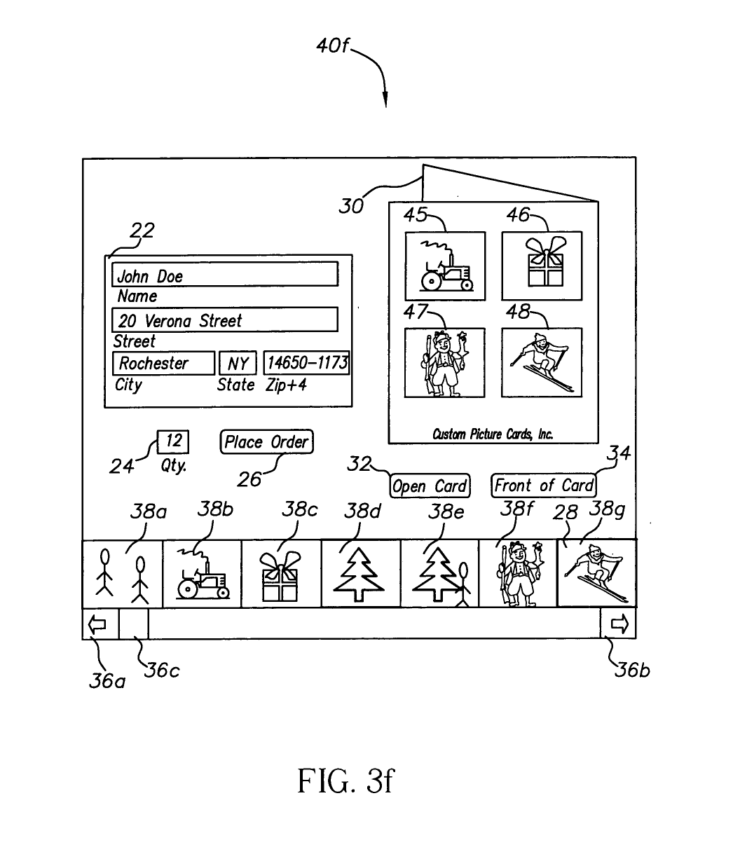

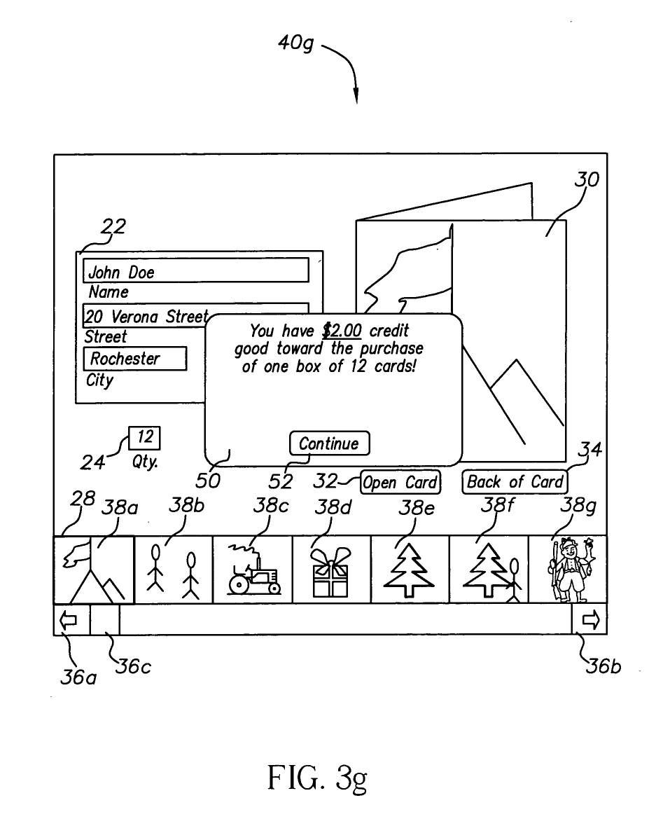

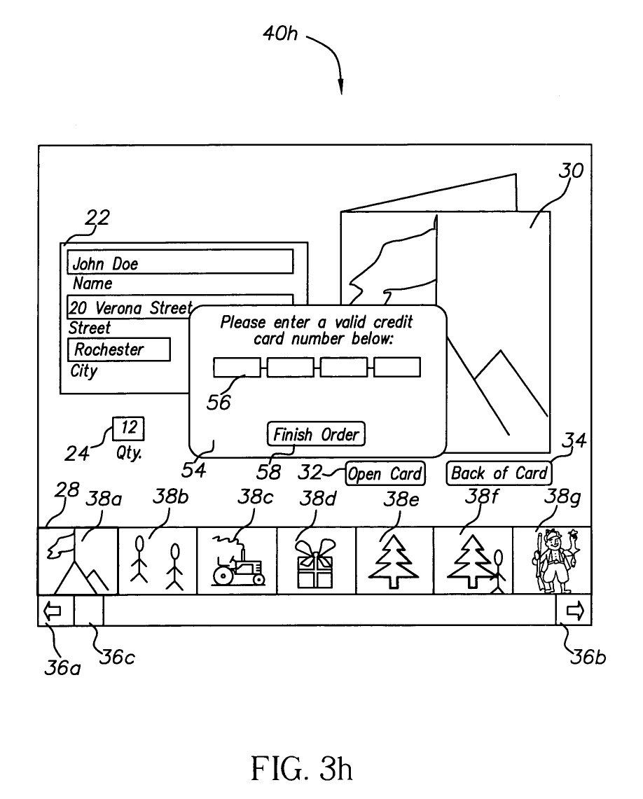

If the user wishes to place an order for the customized image product using the default selection of digital image content 38a, he inputs his address information into address block 22 and the desired quantity input into the quantity block 24 as depicted by screen 40a in FIG. 3a (like numbers indicating like parts and operation). To further customize the image product to be produced, the user activates button 32 to open the template 30 to the interior of the card to add a text message to message block 42 as depicted in screen 40b of FIG. 3b.

Similarly, the user activates button 34 to change the template view to the back page as shown by screen 40c of FIG. 3c. The back page of template 30 includes four digital image content locations 44, 45, 46, and 47 for the placement of selected pictures. The sequence of screens 40c, 40d, 40e, and 40f illustrated in FIGS. 3c, 3d, 3e and 3f respectively (like numerals indicating like parts and operation) depict the process of selecting digital image content 38 for placement into digital image content locations 44, 45, 46 and 47. In FIG. 3t; the user has used content control elements 36b and/or 36c to reveal additional digital image content 38g for placement in digital image content location 47.

Turning now to FIG. 3g, screen 40g is shown that is the result of the user activating button 26 for placing an order. The activated software program includes communication protocol that is pre-configured to communicate with a fulfillment provider in a conventional manner over a network such as the Internet using a protocol standard such as the File Transfer Protocol (ftp). Upon establishing such communication, the fulfillment provider accesses a database with the unique identifier provided by the activated software program from the computer readable media. The result of the database access results in the user computer displaying credit information block 50 in screen 40g. The user acknowledges the information provided by the credit information block 50 by activating a button 52 and thus allows the next step in the ordering process to proceed in FIG. 3h. Screen 40h includes a credit card information block 54, with credit card number field 56, and a button 58 activated for the completion of the order. Completion of the order includes the transmission of the unique ID of template 30, the selected images (or image identifiers for images already accessible to the fulfillment provider), the text message(s), delivery address(es), and credit card information. Reuse of the computer readable media 10 to produce another customized image product is an identical process with the exception that the credit associated with the encrypted unique ID has been consumed. The user would therefore, not be presented screen 40g.

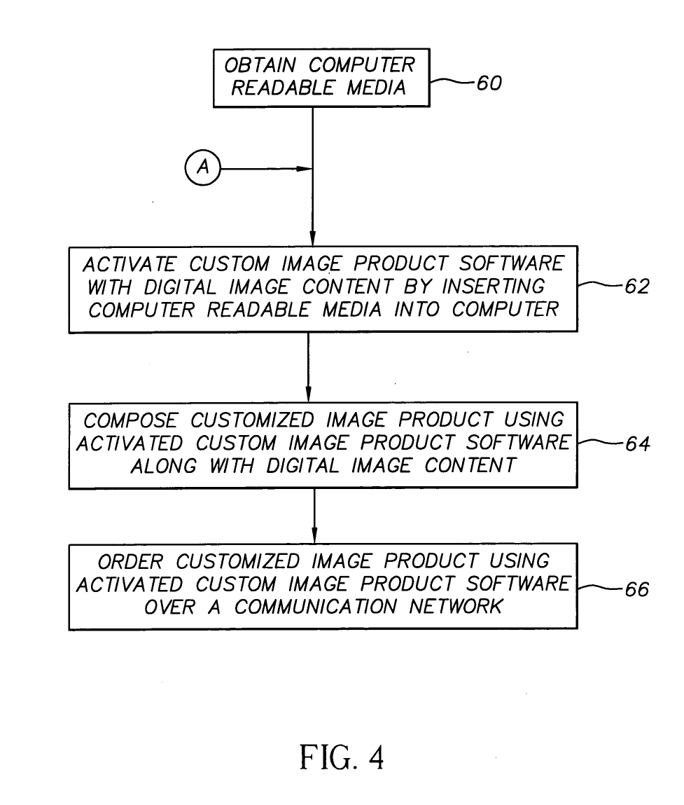

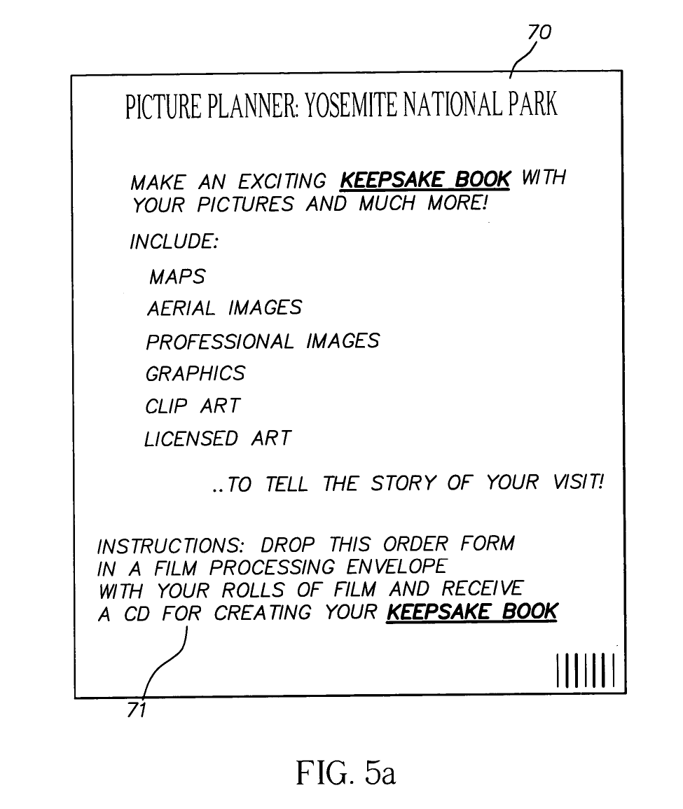

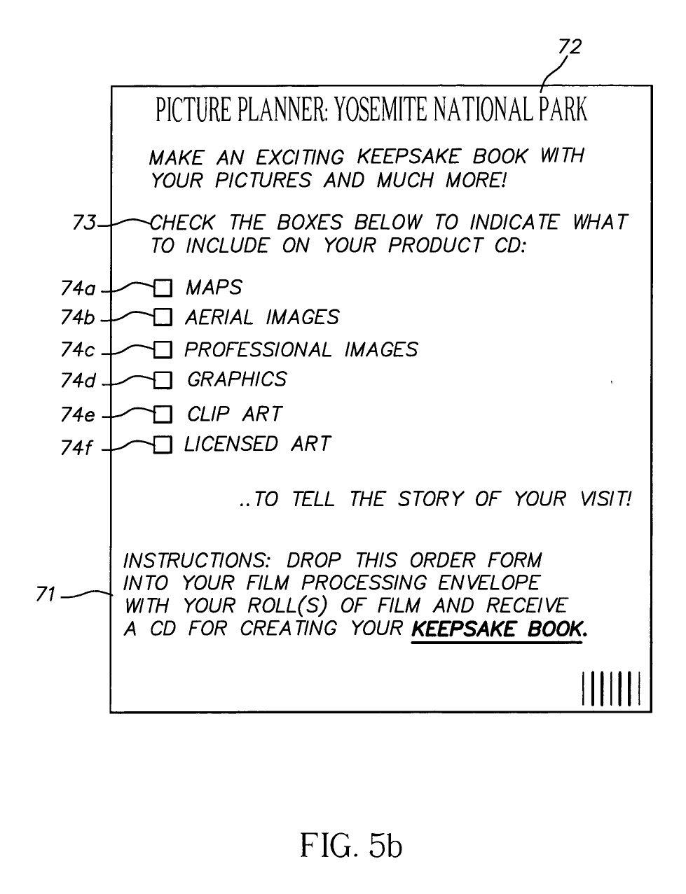

Turning now to FIG. 4, a flow chart is shown that describes the steps in the method of creating a customized image product. The method begins in step 60 with the user obtaining a computer readable media 10 such as a CD the contents of which have been described earlier. The user may obtain such a computer readable media 10 from a variety of sources some of which may allow him to include his own personal digital image content 38. Examples of this will be discussed further with respect to FIGS. 5A-8. The user of the computer readable media 10 may receive it from a third party as a gift, or the user may obtain the computer readable media 10 for his own purposes. In either event, the disk is inserted into the CD drawer, and the software program is activated (step 62) by a common computing feature known as AutoPlay. The software program allows the user to interactively compose (step 64) the customized image product by adding selected digital image content 38 to the template 30. When satisfied, the user orders (step 66) the customized image product over a communication network from a fulfillment site. Preferably, the software program can predetermine the fulfillment site so as to not burden the user with that effort, or a choice could be provided as an option. In addition since the software is not loaded on to a particular computer and/or other device, the user may use any computer that is conveniently available to the user. Thus the user may use the software where purchased on any appropriate device for running computer programs and having communication capabilities.

In step 60, a user obtains a computer readable media 10 for initiating the composition and creation of the customized image product. There are several ways that will now be discussed in which the user can order a computer readable media 10 that includes both predetermined and/or selectable digital image content 38 plus his own personal digital image content 38. In FIG. 5a, an order form 70 is shown for ordering a computer readable media 10 that includes stock digital image content 38 in addition to digital image content 38 supplied by the user, for example but not limited to, in the form of exposed film images. In this particular example, the order form 70 informs the user that the customized image product to be created will be a keepsake book and that supplied digital image content will include maps, aerial images, professional images, graphics, clip art and licensed art of Yosemite National Park. Instructions 71 on the order form 70 explain how to use the order form with the film processing envelope (not shown). In a similar manner in FIG. 5b, another order form 72 is shown with like numerals indicating like parts and operation. In this example, order form 72 allows the user to select which digital image content 38 is to be supplied with the computer readable media 10 by checking selection boxes 74a-74f. The selection of digital image content 38 may cause an additional fee to be applied to the cost of the computer readable media 10 as indicated by selection instructions 73.

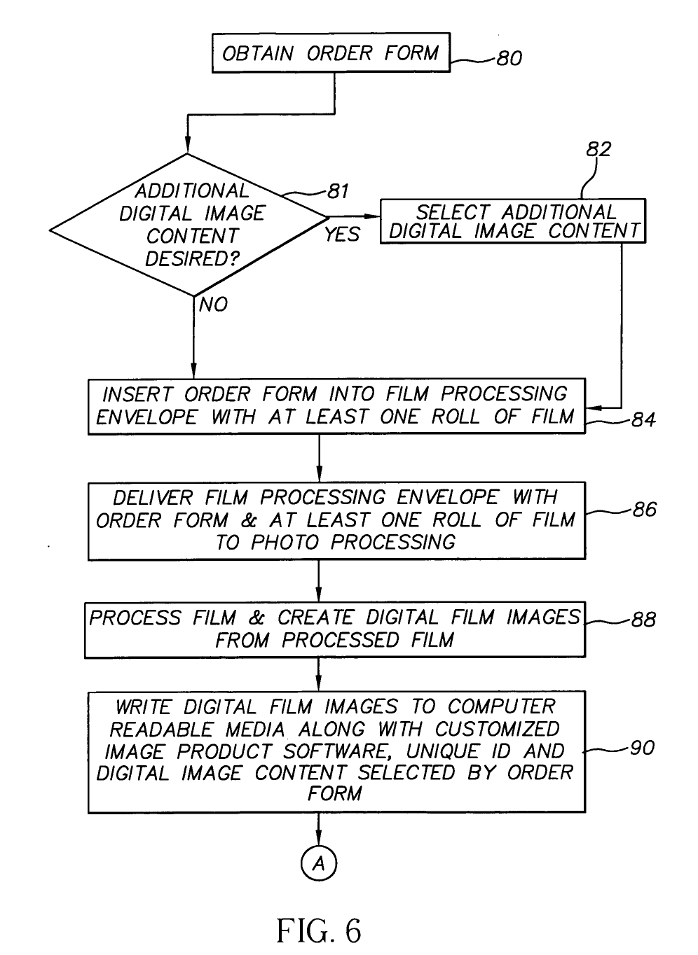

In FIG. 6, the steps to create a computer readable media 10 with user supplied exposed film images and order form 70 are detailed. First the user must obtain an order form 70 (step 80) from a retail counter for example. If order form 72 is obtained, the user determines (step 81) whether or not to add additional digital image content 38 to the computer readable media 10. If yes, the user selects (step 82) additional digital image content 38. At this point, the user inserts (step 84) order form 70 or order form 72 into the film processing envelope along with one or more rolls of exposed, but undeveloped film. The order processing envelope is delivered (step 86) to a photo processing station or facility where the exposed film is processed (step 88) and from which digital images are created from the processed film images typically by scanning the processed film images. The computer readable media 10 is returned to the user after all the data including digital image content 38, the unique ID, and any credit has been successfully written (step 90) to the computer readable media 10. The process of creating a customized image product with this media 10 resumes at point A illustrated in FIG. 4.

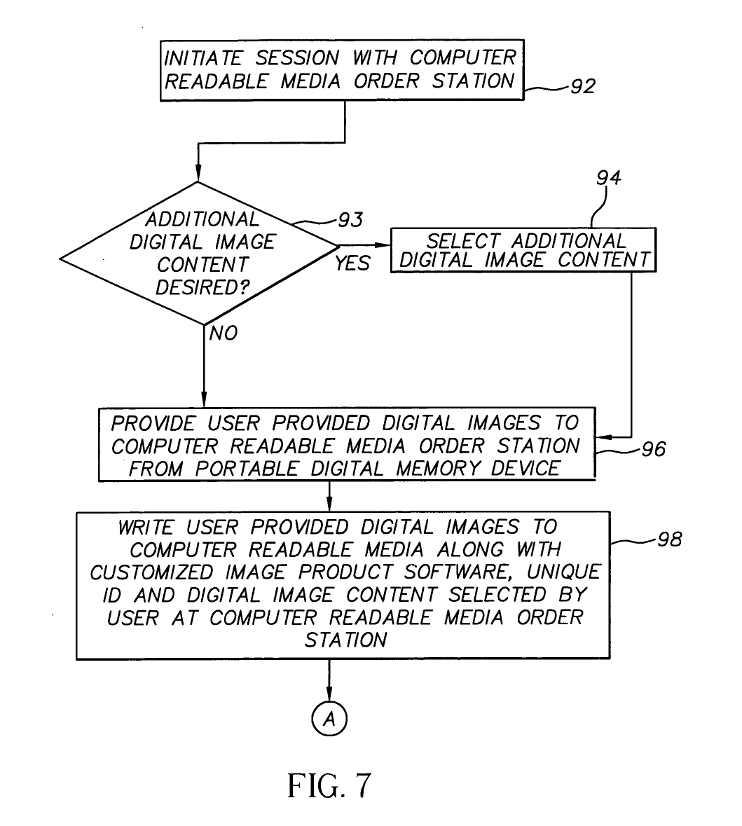

Another example of how a user can provide digital image content 38 for computer media 10 is described in the steps of the flow chart illustrated in FIG. 7. In this example, a computer readable media order station or kiosk (not shown) is operated by a user who initiates a session (step 92) for producing a media 10 as has been described above. In this example, the user also has the option in steps 93 and 94 to add additional digital image content 38 to the media 10. After this decision and action, the user provides (step 96) digital image content 38 to the order station from a portable memory device such as a compact flash card, SD card, memory stick, digital still camera, or a plurality of similar devices all capable of providing digital image content 38 from a user. The order station writes (step 98) the user supplied digital image content 38 along with user selected digital image content 38, a unique ID to encode the chosen template 30 and any credit applied to the media 10 toward the fulfillment of a customized image product. The process of creating a customized image product with this media 10 resumes at point A illustrated in FIG. 4.

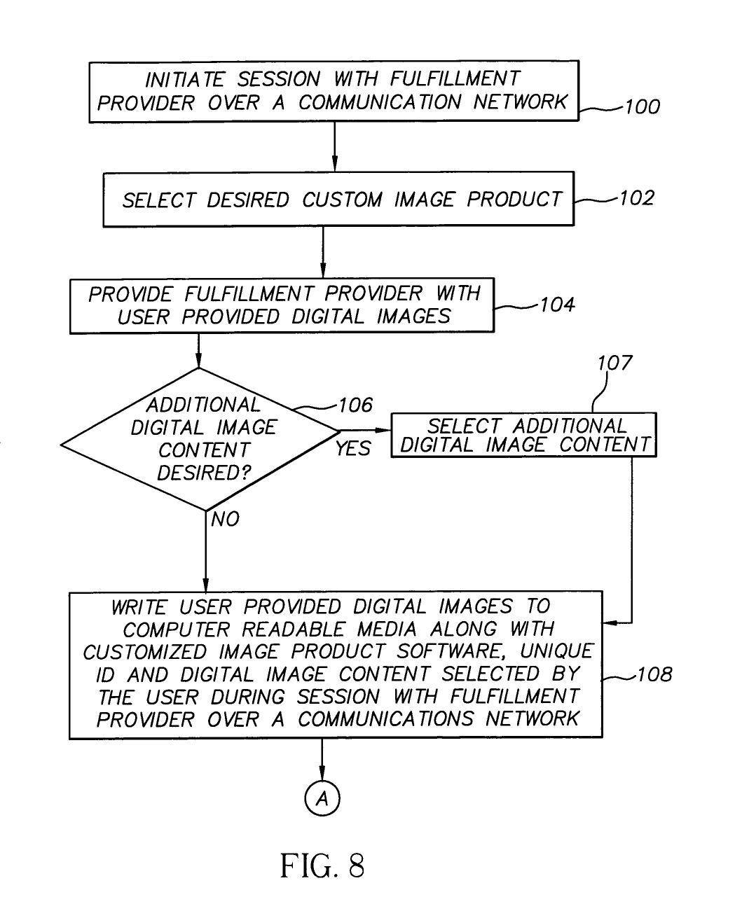

Another example of how a user can provide digital image content 38 for computer media 10 is described in the steps of the flow chart illustrated in FIG. 8. In this example, a user initiates (step 100) a session with fulfillment provider over a communication network. The user then selects (step 102) the desired customized image product template 30 and provides (step 104) the fulfillment provider with digital image content 38. This digital image content 38 may need to be uploaded to the fulfillment provider or it may already have been uploaded. Using steps 106 and 107, the user can select additional digital image content 38 to be included with computer readable media 10. The fulfillment provider writes (step 108) the digital image content 38, the software program, the unique ID, and the customized product template 30 to the computer readable media 10. The process of creating a customized image product with this media 10 resumes at point A illustrated in FIG. 4.

The invention has been described in detail with particular reference to certain preferred embodiments thereof, but it will be understood that variations and modifications can be effected within the spirit and scope of the invention.

### Parts List

10 computer readable media
12 retail media package
14 label
20 initial screen
22 address block
24 quantity block
26 button
28 highlight outline
30 template
32 button
34 button
36a-36c content control element
38 image content
38a-38g digital image content
40a-40h screen
42 message block
44 content locations
45 content locations
46 content locations
47 content locations
50 information block
52 activating button
54 block
56 number field
58 button
60 method
62 activating step
64 step
66 step
70 order form
71 instructions
72 order form
74a-74f selection boxes
80-82 step
84 step
86 step
88 step
90 step
92-94 step
96 step
98 step
100 step
102 step
104 step
106 step
107 step
108 step

1. A method for providing a customized image product to a user, comprising the steps of;
obtaining a computer readable media having a software program such that when said computer readable media is placed in a user computer said software will cause said user computer to perform a predefined series of steps used to create said customized image product from a template, said computer readable media provides for accessing digital image content, a credit toward the cost of said customized image product, and a unique identifier;
loading said computer readable media in said user computer and thereby causing activation of said software, said software automatically allowing use of said digital image content;
said user composing said customized image product; and
said user ordering said customized image product wherein said unique identifier is used to identify said credit and said template.

2. A method according to claim 1 wherein said computer readable media comprises one of the following:
a CD,
a computer floppy (removable magnetic, consider that compact flash goes up to 1 Gigabyte today which is more storage than a CD, although hugely more expensive in its current form? See section in paragraph one of the detailed description) disc.

3. A method according to claim 1 where said customized image product comprises one of the following:
a book,
a post card,
a greeting card.

4. A method according to claim 1 wherein credit comprises the full cost of said customized image product.

5. A method according to claim 1 wherein said template is provided on said computer readable media.

6. A method according to claim 1 wherein software program provides for communication with a fulfillment provider over a communication network for placement of said order.

7. A method according to claim 6 wherein said unique identifier is used to obtain said digital image content from said fulfillment provider.

8. A method according to claim 1 wherein said digital image content is provided on computer readable media.

9. A method according to claim 1 wherein said digital image content was obtained with respect to image(s) that were captured on film and scanned so as to create said digital image content.

10. A method according to claim 6 wherein said unique identifier is used to obtain said template from said fulfillment provider.

11. A computer readable media having a software program such that when said computer readable media is placed in a user computer said software will cause said user computer to perform a predefined series of steps used to create said customized image product from a template, said computer readable media further includes digital image content, a credit toward the cost of said customized image product, and a unique identifier, said software automatically allowing use of said digital image content upon activation and for ordering said customized image product; said software have information for allowing said ordering over a communication network.

12. A method according to claim 11 wherein said computer readable media comprises one of the following:
aCD,
a computer floppy disc.

13. A method according to claim 11 where said customized image product comprises one of the following:
a book,
a post card,
a greeting card.

14. A method according to claim 11 wherein credit comprises the full cost of said customized image product.

15. A method according to claim 11 wherein said template is provided on said computer readable media.

16. A method according to claim 11 wherein software program provides for communication with a fulfillment provider over a communication network for placement of said order.

17. A method according to claim 16 wherein said unique identifier is used to obtain said digital image content from said fulfillment provider.

18. A method according to claim 11 wherein said digital image content is provided on computer readable media.

19. A method according to claim 11 wherein said digital image content was obtained with respect image that were captured on film and scanned so as to create said digital image content.

20. A method according to claim 16 wherein said unique identifier is used to obtain said template from said fulfillment provider.

21. A method for providing a customized image product to a user, comprising the steps of;
obtaining a computer readable media having a software program such that when said computer readable media is placed in a user computer said software will cause said user computer to perform a predefined series of steps used to create said customized image product from a template, said computer readable media further includes digital image content, a credit toward the cost of said customized image product, and a unique identifier, said software further allows the user to obtain additional digital images from other sources that can also be used to compose said customized image product;
loading said computer readable media in said user computer and thereby causing activation of said software, said software automatically allowing use of said digital image content and said additional digital images;
said user composing said customized image product; and
said user ordering said customized image product wherein said unique identifier is used to identify said credit and said template.

22. A method according to claim 21 wherein said computer readable media comprises one of the following:
a CD,
a computer floppy disc.

23. A method according to claim 21 where said customized image product comprises one of the following:
a book,
a post card,
a greeting card.

24. A method according to claim 21 wherein credit comprises the full cost of said customized image product.

25. A method according to claim 21 wherein said template is provided on said computer readable media.

26. A method according to claim 21 wherein software program provides for communication with a fulfillment provider over a communication network for placement of said order.

27. A method according to claim 26 wherein said unique identifier is used to obtain said digital image content from said fulfillment provider.

28. A method according to claim 21 wherein said digital image content is provided on computer readable media.

29. A method according to claim 21 wherein said digital image content was obtained with respect image that were captured on film and scanned so as to create said digital image content.

30. A method according to claim 26 wherein said unique identifier is used to obtain said template from said fulfillment provider.

31. A method for providing a customized image product to a user, comprising the steps of,
providing a plurality of images by said user to a fulfillment provider;
said fulfillment provider providing a computer readable media having a software program such that when said computer readable media is placed in a user computer said software will cause said user computer to perform a predefined series of steps used to create said customized image product from a template, said computer readable media further includes digital image content which includes said images provided to said fulfillment provider, a credit toward the cost of said customized image product, and a unique identifier;
loading said computer readable media in said user computer and thereby causing activation of said software, said software automatically allowing use of said digital image content;
said user composing said customized image product; and
said user ordering said customized image product wherein said unique identifier is used to identify said credit and said template.

32. A method according to claim 31 wherein said plurality of images provided to said fulfillment provider comprises a film product.

33. A method according to claim 32 where said film product comprises undeveloped film that needs to be developed and scanned in order to obtains said digital images.

34. A method according to claim 31 wherein an order form is used to identify a particular type image product from which said customized image product is to be made.

35. A method according to claim 31 wherein said order form is used to identify digital image content to be included in said computer readable media.

36. A method according to claim 35 wherein at least one of said identified digital image content is royalty bearing.

37. A method according to claim 31 wherein said plurality of images are provided to said fulfillment provider over a communication network.

38. A method for providing a customized image product to a user, comprising the steps of;
providing a plurality of images by said user to a computer readable media order station;
said computer readable media order station providing a computer readable media having a software program such that when said computer readable media is placed in a user computer said software will cause said user computer to perform a predefined series of steps used to create said customized image product from a template, said computer readable media further includes digital image content which includes said images provided to said fulfillment provider, a credit toward the cost of said customized image product, and a unique identifier;
loading said computer readable media in said user computer and thereby causing activation of said software, said software automatically allowing use of said digital image content;
said user composing said customized image product; and
said user ordering said customized image product wherein said unique identifier is used to identify said credit and said template.

39. A method according to claim 38 wherein said plurality of images provided by said user on a portable digital memory device.

40. A method according to claim 38 wherein said plurality of images provided by said user on a digital image capture device.

41. A method according to claim 38 wherein said computer readable media comprises one of the following:
a CD,
a computer floppy disc.

42. A method according to claim 38 where said customized image product comprises one of the following:
a book,
a post card,
a greeting card.

43. A method according to claim 38 wherein credit comprises the full cost of said customized image product.

44. A method according to claim 38 wherein said template is provided on said computer readable media.

45. A method according to claim 38 wherein software program provides for communication with a fulfillment provider over a communication network for placement of said order.

46. A method according to claim 45 wherein said unique identifier is used to obtain said digital image content from said fulfillment provider.

47. A method according to claim 38 wherein said digital image content is provided on computer readable media.

48. A method according to claim 38 wherein said digital image content was obtained with respect image that were captured on film and scanned so as to create said digital image content.

49. A method according to claim 45 wherein said unique identifier is used to obtain said template from said fulfillment provider.
